(19) United States
(12) Patent Application Publication
(10) Pub. No.: US 2013/0232013 A1
(43) Pub. Date: Sep. 5, 2013

(54) Apparatus and Method for Facilitating Personalized Marketing Campaign Design

(71) Applicants: Michael David Shepherd, Ontario, NY (US); Dale Ellen Gaucas, Penfield, NY (US); Ranen Goren, Closter, NJ (US); Reuven J. Sherwin, Ra'anana, IL (US); Kirk J. Ocke, Ontario, NY (US)

(72) Inventors: Michael David Shepherd, Ontario, NY (US); Dale Ellen Gaucas, Penfield, NY (US); Ranen Goren, Closter, NJ (US); Reuven J. Sherwin, Ra'anana, IL (US); Kirk J. Ocke, Ontario, NY (US)

(73) Assignee: Xerox Corporation, Norwalk, CT (US)

(21) Appl. No.: 13/412,450

(22) Filed: Mar. 5, 2012

(51) Int. Cl. G06Q 30/02

(52) U.S. Cl. 705/14.67

(57) ABSTRACT

Embodiments of the disclosure simplify the design process by drawing inferences based on data input by the user and making design suggestions to the user. In accordance with one aspect of the present disclosure, apparatus are provided that assist users in the design of a personalized marketing campaign. A user interface is disclosed that allows the user to input data and receive information. A personalized marketing campaign knowledge database is disclosed that contains data encoding concepts extracted from complete personalized marketing campaigns and semantic definitions of those concepts. A semantic inference engine is also disclosed which draws inferences based on a comparison of the semantics of the data entered by the at least one user and the semantic definitions of the concepts encoded in the knowledge database, and communicates those inferences to the at least one user to assist the user in construction of the marketing campaign.

### COPYRIGHT NOTICE

This patent document contains information subject to copyright protection. The copyright owner has no objection to the facsimile reproduction by anyone of the patent document or the patent, as it appears in the US Patent and Trademark Office files or records, but otherwise reserves all copyright rights whatsoever.

### FIELD OF THE DISCLOSURE

Aspects of the present disclosure relate to communications systems configured to help users create and send communications. Other aspects relate, e.g., to personalized marketing campaign design systems.

### BACKGROUND

Personalized communications systems may be used to create Personalized Marketing Campaigns, such as Variable Data Marketing Campaigns, allow a user to design communications that contain information tailored specifically for each recipient. Such communications include several possible pre-defined campaign products, such as mailings, flyers, postcards, electronic mail blasts, and the like. Presently, marketers, designers, and print providers can create such campaigns within the structure provided by various products designed to aid in the creation of those campaigns. Such users must use a pre-defined lexicon of terms that is accepted and understood by the campaign design products, and the products lack the ability to provide guidance and feedback to the user.

### SUMMARY

In accordance with one aspect of the present disclosure, apparatus are provided that assist users in the design of a personalized marketing campaign. A user interface is disclosed that allows the user to input data and receive information. A personalized marketing campaign knowledge database is disclosed. The personalized marketing campaign knowledge database contains data that encodes concepts extracted from complete personalized marketing campaigns and semantic definitions of those concepts. A semantic inference engine is also disclosed. The semantic inference engine draws inferences based on a comparison of the semantics of the data entered by the at least one user and the semantic definitions of the concepts encoded in the knowledge database, and communicates those inferences to at least one user to assist the user in construction of the marketing campaign.

### BRIEF DESCRIPTION OF THE DRAWINGS

FIG. 1 is a block diagram depicting one embodiment of an apparatus for the creation of a personalized marketing campaign, including the automatic detection of errors and inconsistencies.

FIG. 2 is a flowchart of an embodiment of a process for the creation of personalized marketing campaigns which shows interaction between the workflow and the marketing campaign knowledge model, including the automatic detection of errors and inconsistencies, is depicted.

FIG. 3 is a block diagram depicting an embodiment of a user interface used by a user to construct a personalized marketing campaign using an unstructured campaign workflow.

FIG. 4 is a flowchart of an embodiment of an example process for drawing an inference from semantic data entered by the user and guiding the user in the creation of the marketing campaign based on that inference.

FIG. 5 is a block diagram depicting an exemplary embodiment of a personalized marketing campaign workflow case study.

### DETAILED DESCRIPTION

Compliance with the structural and lexicographic requirements of personalized marketing campaign design programs makes the creation of variable data campaigns complicated and time consuming.

The use of the disclosed apparatus and methods in the creation of marketing campaigns, allows for automated guidance for the design of personalized marketing campaigns. The automated structure can be grounded by the campaign knowledge model and can use reasoning systems to ensure consistency of vocabulary. This is especially useful for collaborative creation of variable data campaigns by multiple collaborators. The automated structure grounded by the campaign knowledge model and using the reasoning systems can ensure a consistent vocabulary among the collaborators, can check for consistency among the campaign's various components, and detect errors as the campaign is constructed by the collaborators, as well as suggest campaign components.

Aspects of the disclosure relate to an apparatus for the creation of personalized marketing campaigns, such as variable data marketing campaigns. Embodiments of the apparatus include an inference engine and automated reasoning system to guide users through the creation of the campaign. Such assistance can include, in embodiments, automatically suggesting components and/or information for the user to include in the campaign, automatically checking for inconsistencies across the campaign components, and automatically detecting likely user errors in the construction of the campaign. In embodiments, the user may be automatically alerted of such errors and/or inconsistencies, and can be automatically notified of the components and/or information suggested for inclusion. In other embodiments, detected errors, inconsistencies, or missing information, etc., may be automatically corrected without any notification to the user. In embodiments, the user can select whether the user wishes to be alerted to such changes, or whether the user prefers to have such changes automatically entered. In embodiments, the user can choose to be alerted to some types of changes, and to have others occur automatically.

Embodiments of the disclosure simplify the campaign design process by drawing inferences regarding the campaign being designed, based on the campaign design data input by a user. In embodiments, the campaign design process is simplified by allowing for an unstructured approach by which the user could plan, review, and execute a personalized variable data campaign workflow. For example, one or more free-form text fields can be provided in which the user could describe the content and context of a marketing campaign using natural language.

Embodiments of the disclosure provide an inference engine that uses automatic reasoning to create a system capable of semantic inference from the natural language data entered by a user, where such inferences are based on the semantic definitions of concepts of marketing campaigns stored in a knowledge database. This allows for a structured, but semantic approach to the personalized creation of variable data marketing campaigns, either by an individual or by a collaborative group. Without such an inference engine, collaboration between multiple users is difficult, in part because of errors and inconsistencies in the vocabulary used by the various collaborators on a campaign.

In embodiments, the inference engine uses an automated reasoning system to automatically draw inferences from comparisons of the data supplied by a user and data stored in a knowledge database. In embodiments, the inferences drawn by the inference engine can be communicated to the user, and can be used to facilitate the creation of the campaign. In various embodiments, the inferences can be used to check for errors or inconsistencies in the campaign, to ensure a consistent vocabulary, and to suggest additional actions the user may take in the creation of the campaign.

The automatic suggestions and consistency checking is accomplished with the use of a campaign knowledge model and inferencing engine that captures the know-how of personalized campaign creation. Through knowledge engineering of the real-world concepts, relationships, and structure of personalized marketing campaigns, a knowledge representation is constructed that is usable by automated reasoning systems (such as open world reasoners and rule-based systems) that results in a system capable of semantic inference unique to marketing campaigns. The result of the reasoning system's application to the knowledge representation is, in embodiments, apparatus and methods capable of semantic inference unique to marketing campaigns.

In embodiments, an inference engine draws inferences, at least in part, by considering data regarding the design of other marketing campaigns stored in a knowledge database. The knowledge database may contain encoded concepts extracted from complete personalized marketing campaigns, and semantic definitions of those concepts. The data may be knowledge engineered from existing complete personalized marketing campaigns. Through the knowledge engineering, personalized marketing campaign concepts are identified, and semantic definitions of those concepts are created.

The campaign components include concepts such as Touchpoints with the campaign targets, the messages being conveyed to the targets, the relationships between the Touchpoints that define the campaign workflow, and the campaign's business objective.

Concepts identified from such existing personalized marketing campaigns can be, for example:
a. Business Objectives
b. Call-To-Actions
c. Campaign Types, (i.e. campaign semantically classified as being targeted to a particular vertical market (e.g. Healthcare, Education, Retail etc.), to achieve a particular Business Objective, etc.)
d. Channels
e. Data Categories
f. Data Sets
g. Data Sources
h. Events
i. Human Actions
j. Incentives
k. Informational Content
l. Messages
m. Recipient Type
n. Timing
o. Touchpoints
p. Tracking
q. Vertical Markets

Each concept can be further subdivided into subconcepts. For example, “Messages” can include subcategories of confirmations, donations requests, invitations, product offers, registrations, solicitations, teasers, and “thank you” messages. Each of these concepts may be semantically defined, and those semantic definitions may be encoded and loaded into the knowledge data base.

In embodiments of the disclosure, when the user enters data that matches a semantic definition of a concept in the knowledge database, the inference engine draws the inference that the user is attempting to add that identified personalized marketing campaign concept to the user's campaign design. Guidance, instructions, or suggestions for the design of a successful personalized marketing campaign with the identified concept can then be communicated to the user. Alternatively, in embodiments, a complete campaign design incorporating the identified concepts can be suggested to the user.

As one example, where a user enters data matching the semantic definition of the campaign concept “Message”, such as text reading “send thank you”, the user can be presented with suggestions, for example, as to whom such messages are often sent in the type of campaign the user is designing, or what information is often included in such a message, e.g., address information. Similar suggestions can be made for each concept identified as the user enters data for the creation of the campaign.

Conversely, where the user has not entered data matching the semantic definition, but instead enters or selects the concept itself; i.e., in the example above the user entered “Message”, the inference engine can infer the semantics of the message based on its context within the campaign. For example, if the user enters “send Message” or selects “Message” from a menu of selectable concepts, the system can infer that the user is attempting to create a “Thank you” message based on where the message occurs in the campaign workflow, and can suggest, for example, appropriate content, actions, timing, and/or recipients. Again, similar suggestions can be made for each campaign concept as the user enters data for the creation of a campaign.

One embodiment of an approach for providing a structured, semantic workflow for the collaborative creation of personalized marketing campaigns is as follows:

Multiple case studies, for example approximately twenty case studies, of successful personalized marketing campaign may be knowledge engineered to extract and represent the various types of content in each campaign. Examples of such case studies have been published by PODi, the Digital Printing Initiative. The semantic concepts within each campaign may be captured and represented along with the campaign contents into a knowledge model. The knowledge modeling language chosen may have the capability to 1) use Description Logics to encode semantic definitions of the campaign concepts; 2) use an automated reasoning system to infer semantic meaning of campaign content; and 3) use rules and queries to further infer additional (non-asserted) knowledge about campaigns during their creation. An example of such a language that may be used, in embodiments, is OWL (the Web Ontology Language). Campaign concepts captured in the knowledge model may include, for example: “Call-To-Actions”, “Touchpoints”, “Messages”, “Incentives”, “Business Objectives”, “Communication Channels”, and “Recipient Lists”, etc.

Most campaign concepts have their own taxonomy. For instance, a campaign “Message” can be of one or more types of messages, including “Invitation”, “Product Offer”, “Registration”, “Request for Information”, “Thank You's”, etc. Specific types of Touchpoints may include “Meetings” or “Reminders”.

The terminology and semantic definitions, for various embodiments, can be engineered directly out of campaign case studies, such as the studies described above. Semantic definitions can be encoded, for example, using a First Order Logic, such as Description Logics, so that automated semantic reasoners are able to determine to which concepts any particular instantiated instance belongs. For instance, in embodiments, as a user is creating their campaign workflow, they may create instances of campaign elements (such as, for example, Touchpoints, Messages, Content that appears in the documents for a particular channel (e-mail, web, print, etc.)). As this information is instantiated into the knowledge model, the automated reasoning infers additional information about the campaign workflow that may be of interest to the user. This new information may then be conveyed back to the user through the user interface. Some examples of what the new information may consist of include: new concepts that describe the campaign element; new node detail added to the campaign element; validation warnings attributed to the workflow; and suggestions to the user about adding new workflow content.

The representation of the actual case studies in the knowledge model as instances of campaign workflow also provides for the intelligent automated extraction of suggestions to be made to the user that are based on real-world successful marketing campaigns.

Some examples of use cases for marketing campaign creation that can be automated in certain embodiments using the approach described herein include:

Offering an enumerated list of “Call-To-Actions” (seeking actions from a recipient) that are relevant for the particular type of “Messages” (e.g. Invitation provides potential Call-To-Actions such as Visit PURL (Personalized URL), Visit Store, Visit Web Site, etc.);

Inferring the particular type of Message based on the Call-To-Actions provided by the user (e.g. inferring that a Message is an invitation based on user input of text such as “Visit Store” as a Call-to-Action);

Recommending additional Touchpoints to add to the campaign workflow based on analysis of the successful case studies (e.g., recommending that the user send a “Thank You” Message when the recipient responds to an Invitation Message);

Automatically checking that initial workflow steps provide all the information content required by later workflow steps. (e.g. checking that a user has provided a Phone Number in a previous Touchpoint when setting up a teleconference Meeting, or that all necessary recipient address information has been provided in a previous Touchpoint when the user prepares to send a Postcard.);

Automatically synchronizing informational content between related Touchpoints (e.g., in cases where a Touchpoint is inferred by the inference engine to be a Reminder Touchpoint, the Reminder Touchpoint would automatically include the same Message information as the previous initial Touchpoint's Message.);

Inferencing of the most commonly used data categories in the campaign for a particular identified campaign type (for instance the inference engine identifies that the user is creating an Education campaign type, and therefore should typically include, for example, recipient data of College Major, Donor Status, Graduation Year, Favorite Professor, and that a Retail campaign typically includes recipient data such as Historical Spending, Shopping Frequency, Date of Last Visit, Book Genre Preference.);

Automatically checking the Temporal Consistency between workflow items (e.g., a Reminder to redeem a Coupon must not occur after Coupon expiration).

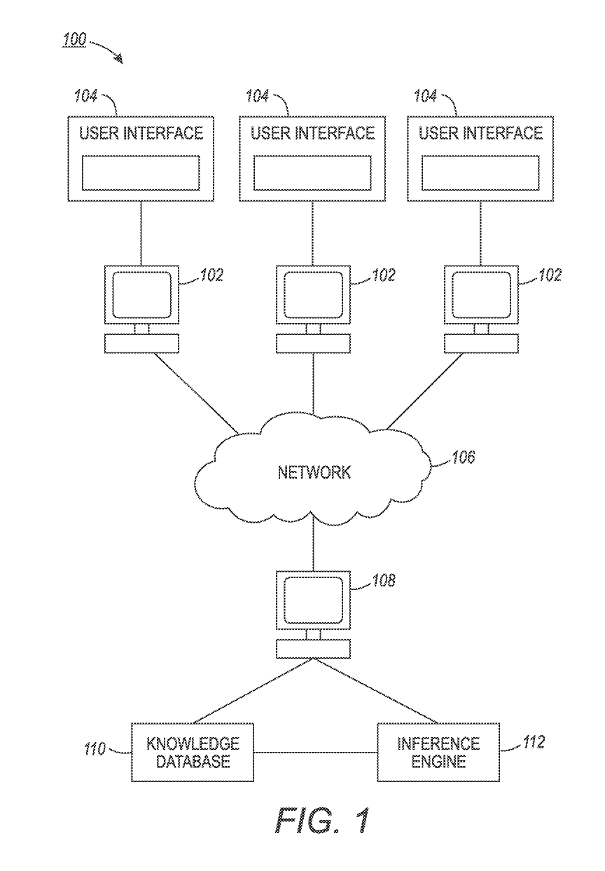

Referring now to the drawings in greater detail, FIG. 1 shows a block diagram depicting one embodiment of an apparatus 100 for the creation of a personalized marketing campaign, including the automatic detection of errors and inconsistencies.

The use of this apparatus of FIG. 1 in the creation of marketing campaigns, especially in a collaborative environment, will provide the campaign collaborators with an automated structure in which to construct the marketing campaigns.

The one or more users is presented a user interface 104, such as a graphical user interface, on a user computer 102, such as a monitor. The one or more user computers 102 either comprises a knowledge database 110 and an inference engine 112, or it is connected to a separate device, such as a computer server, that comprises a knowledge database 110 and an inference engine 112 via a network 106.

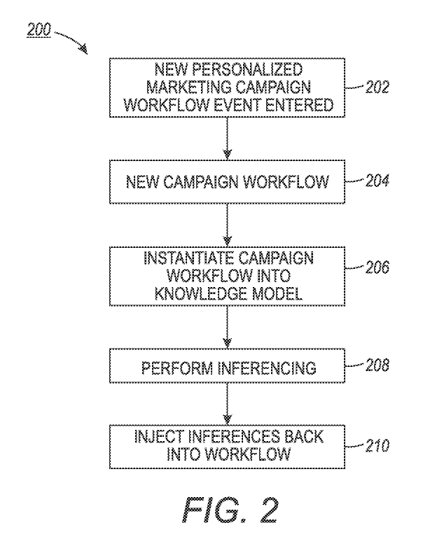

Referring now in detail to FIG. 2, a flowchart 200 of an embodiment of a process for the creation of personalized marketing campaigns is depicted which shows interaction between the workflow and the marketing campaign knowledge model.

In step 202, a new personalized marketing campaign workflow event may be entered by a user.

In embodiments, a new or changed campaign workflow is automatically detected at step 204. This could occur upon a campaign designer saving the campaign workflow, or occur dynamically as the campaign workflow is actively being created.

In embodiments, the campaign workflow is entered by the user and the user entered campaign workflow is instantiated into the knowledge model at step 206.

Inferencing may then be performed to draw inferences based on the user-entered workflow information and the data contained in the knowledge model at step 208.

The inferences drawn in step 208 may then be returned back into the workflow at step 210. Such injection of inferences may be, for example, any of the type described above, such as the suggestion of new instances of campaign concepts (e.g. Touchpoints, Messages, Call To Actions) or alerts to errors, omissions, or inconsistencies.

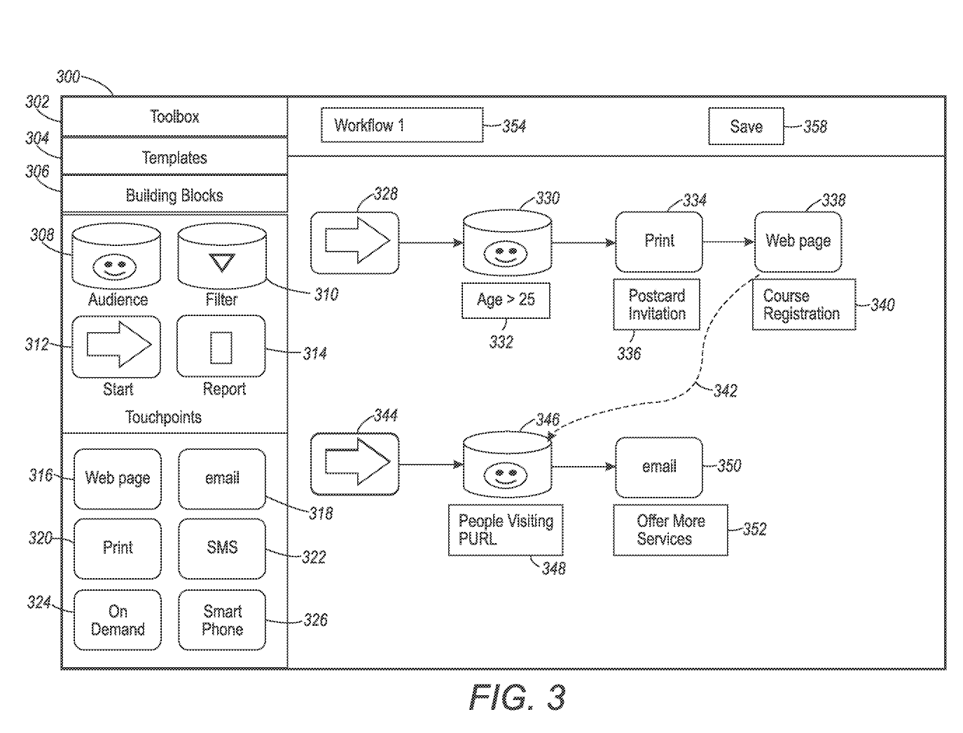

Referring now to FIG. 3 in detail, an embodiment of a user interface 104 that allows the user to create a campaign workflow is depicted 300.

The user interface 300 may provide the user with the ability to name the campaign workflow, and/or categorize it as a particular type of campaign vertical, such as an education campaign, e.g., in a natural language free-form field 354. The user may also be provided the ability to save and later recall and revise a particular campaign workflow, e.g., at 358.

A graphical representation of a toolbox for the creation of a campaign workflow may be provided to the user 302. Such a toolbox may include templates of model campaign flows 304, and such templates may be further categorized for different types of campaign verticals.

The Toolbox 302 may also include exemplary building blocks 306, 308, 310, 312, 314, and templates 316, 318, 320, 322, 324, 326 from which the user can select while building a campaign workflow.

The user may build the campaign workflow by selecting building blocks (e.g., 328, 330, 344, 346) and Touchpoints (e.g. 334, 338, 350). Specific information may be entered for each node (including both building blocks and Touchpoints) using natural language entered into free-form fields (332, 336, 340, 348, 352).

As information is entered by the user, the inference engine draws inferences from that information and, for example, presents the user with alerts regarding errors in the creation of the workflow or omissions of information, and may offer the user suggestions for additional workflow items, such as additional Touchpoints.

The inferences drawn may be fed back into the system to facilitate the creation of additional campaign items. For example, as shown, information regarding which recipients responded to the Postcard invitation by visiting the course registration webpage is feedback 342 to identify recipients who have visited the PURL 346 and who are then targeted for an email 350 offering, e.g., more services 352.

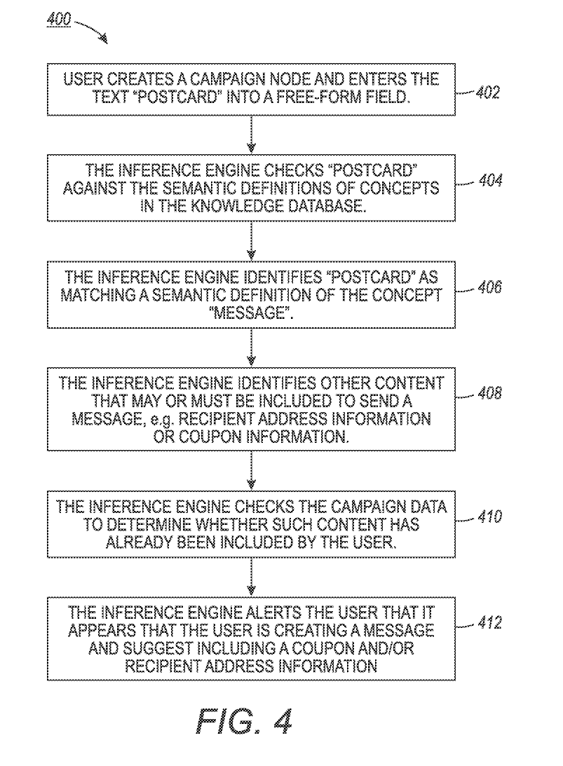

Referring in detail now to FIG. 4, is a flowchart 400 of an embodiment of an example process for drawing an inference from semantic data entered by the user and guiding the user in the creation of the marketing campaign based on that inference. First, the user creates a campaign node and enters the text “postcard” into a free-form field. 402 The Inference Engine then checks “postcard” against the semantic definitions of concepts in the Knowledge Database. 404 In the depicted embodiment, the Inference Engine Identifies “postcard” as matching a semantic definition of the concept “Message”. 406 Next, the Inference Engine identifies other content that may or must be included to send a Message, e.g. recipient address information or coupon information. 408. In embodiments, the inference engine may check the campaign data to determine whether such content has already been included by the user. 410 Finally, the inference engine alerts the user that it appears that the user is creating a Message and suggests including a coupon and/or recipient address information.

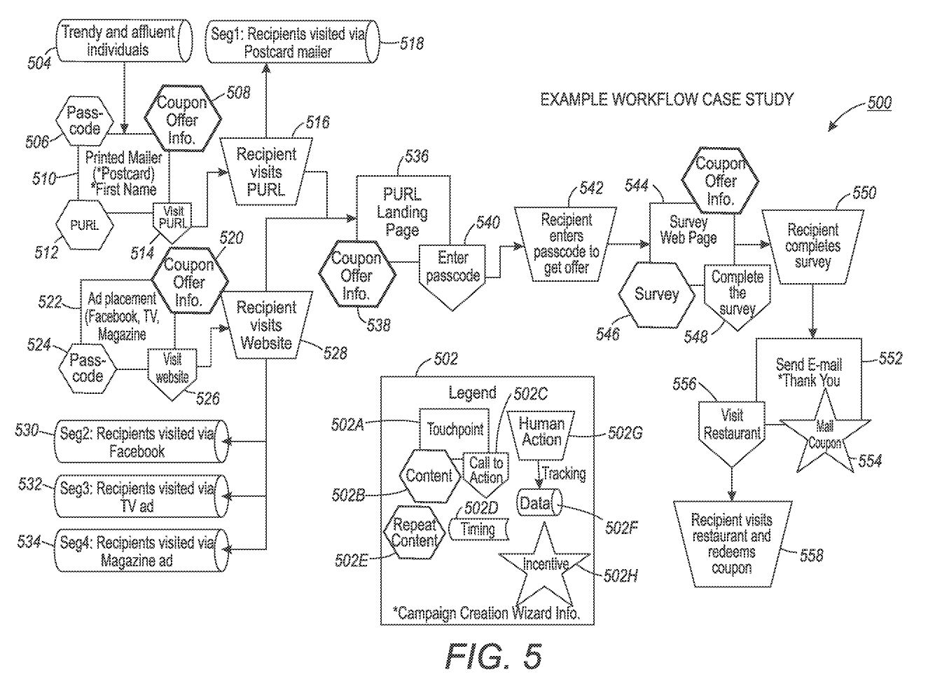

Referring in detail to FIG. 5, an exemplary embodiment of a campaign workflow case study which may be included in the knowledge database is depicted 500. The exemplary case study also demonstrates what the final product of a campaign workflow may be.

A legend 502 indicates how each type of node in a campaign workflow is represented. Each Touchpoint 502A may contain Content 502B and may indicate a Call-to-Action 502C. Each Human Action 502E may be tracked and stored as data 502F. The Timing of each node may also be indicated 502D. An Incentive 502H is provided for the Recipients to take the Call-to-Actions and information about the Incentive is shown as Repeat Content 502E that appears on the Touchpoints throughout the workflow. For this exemplary embodiment, the first Touchpoint 510, is a printed mailer, such as a postcard, sent to recipients in a database of trendy and affluent individuals 504. The Touchpoint 510 requires user-supplied content to be included in the postcard such as a PURL 512, a Passcode 506, and coupon offer information 508. The Call-to-Action 514 is a call to visit the PURL.

The first recipient human action occurs when recipients visit the PURL 516. Information regarding which recipients visited the PURL in response to the postcard invitation is then stored in a database 518.

In embodiments of the current disclosure, as the user enters information for the design of the campaign workflow, the inference engine may draw inferences based on the information entered, and provide feedback to the user to facilitate the design. For example, the user typed in “Postcard”, the user may be presented a prompt suggesting that it appears that the user was seeking to send a message and prompting the user to designate the recipients and indicate the recipient contact information. As another example, when the user entered the coupon offer information content 508, the inference engine may check that the indicated coupon offer expiration date was, for example, after the current date or the expected date of mailing, and—if not—alert the user to the inconsistency. What is depicted in FIG. 5, however, is the end result of the process of designing and running a full campaign 500. In embodiments, the entirety of this information could be fed back into the knowledge database to improve the inferencing ability of the inference engine.

Meanwhile, in the exemplary embodiment of a campaign workflow 500 as depicted in FIG. 5, a separate Touchpoint is the placement of an advertisement in one or more types of media 522. The Content supplied by the user to be included in such an advertisement, such as the pass code 524 and the coupon offer information 520, is also entered by the user.

In the presented embodiment, the Touchpoint Call-to-Action is, again, visiting the PURL 526. The Human Action occurs when a recipient visits the website 528. Information regarding which recipient visited the website, and in response to an advertisement in which media, may be stored in a database 530, 532, 534 as determined by the user entered Passcode.

In embodiments of the current disclosure, as the user enters information for the design of the campaign workflow, the inference engine may draw inferences based on the information entered, and provide feedback to the user to facilitate the design. For example, the user typed in “Ad” or “Advertisement”, the user may be presented a prompt suggesting that it appears that the user was seeking to design an advertisement inviting people to visit a website and prompting the user to indicate varying passcodes 524 which viewers of different types of advertisements could use when accessing the website. What is depicted in FIG. 5, however, is the end result of the process of designing and running a full campaign 500. In embodiments, the entirety of this information could be fed back into the knowledge database to improve the inferencing ability of the inference engine.

In the exemplary campaign workflow embodiment 500 depicted in FIG. 5, the next Touchpoint is the PURL Landing Page 536. This Touchpoint requires the user to supply content such as, for example, the coupon offer information 538, and the Call-to-Action is the entry of the passcode (provided by the user at 512, and 524) by the recipient of the postcard message 510 or the advertisement 524.

In embodiments of the current disclosure, as the user enters information for the design of the campaign workflow, the inference engine may draw inferences based on the information entered, and provide feedback to the user to facilitate the design. For example, the user entered a Call-to-Action of “enter passcode” the inference engine may check to see whether such passcodes were actually supplied by each of the communications to the recipients, e.g., that for each advertisement 522 and each postcard Invitation Message 510 the user supplied the passcodes as necessary content information, as is depicted at 506 and 524. What is depicted in FIG. 5, however, is the end result of the process of designing and running a full campaign 500. In embodiments, the entirety of this information could be fed back into the knowledge database to improve the inferencing ability of the inference engine.

Once the recipient enters the passcode at 542, the recipient is presented with the next Touchpoint designed by the user, a survey web page 544. For the Survey Web Page 544 of the depicted embodiment, the user has supplied survey content information 546, and indicated a Call-to-Action wherein the recipient is called upon to complete the survey 548.

In embodiments of the current disclosure, as the user enters information for the design of the campaign workflow, the inference engine may draw inferences based on the information entered, and provide feedback to the user to facilitate the design. For example, once the user indicated, for example either by selection or entering natural language in a free-form field, that the user was creating a survey, the inference engine may make suggestions as to the type of content that the user may want to include in the survey content 546. Additionally, the inference engine may suggest that the user include the additional touchpoint 552 of sending an email “Thank You” message along with the coupon once the recipient has completed the survey 550, as an additional Touchpoint the user may have neglected to include. The inference engine may also check to ensure that the survey 544 requests the recipient's email address as part of the content of the survey 546, and, if not, alert the user that that such information has been omitted. What is depicted in FIG. 5, however, is the end result of the process of designing and running a full campaign 500. In embodiments, the entirety of this information could be fed back into the knowledge database to improve the inferencing ability of the inference engine.

Once the recipient has completed the survey 550, the final Touchpoint depicted in the exemplary embodiment of a campaign workflow 500 depicted in FIG. 5 is the sending of a “Thank You” email Message along with the Incentive (e.g. coupon). The coupon, for example, may be supplied by the user 554. The email “Thank You” message also includes a Call-to-Action calling for the recipient to visit the business 556, which happens to be a restaurant in the exemplary embodiment of a campaign workflow 500 depicted in FIG. 5. This exemplary embodiment ends with the Human Action of the recipient actually visiting the restaurant and redeeming the coupon 558. When a user indicates that a Touchpoint delivers an Incentive, the inference engine may suggest that the user include Content for the information about the Incentive on all previous touchpoints in the campaign workflow. For instance, if the user had not previously specified Content 508, 520, and 538, upon user creation of Incentive 554, the inference engine would suggest the addition of said Content.

In embodiments of the current disclosure, as the user enters information for the design of the campaign workflow, the inference engine may draw inferences based on the information entered, and provide feedback to the user to facilitate the design. For example, the user typed in “Postcard”, the user may be presented a prompt suggesting that it appears that the user was seeking to send a message and prompting the user to designate the recipients and indicate the recipient contact information. As another example, when the user entered the coupon offer information content 508, the inference engine may check that the indicated coupon offer expiration date was, for example, after the current date or the expected date of mailing, and—if not—alert the user to the inconsistency. What is depicted in FIG. 5, however, is the end result of the process of designing and running a full campaign 500. In embodiments, the entirety of this information could be fed back into the knowledge database to improve the inferencing ability of the inference engine.

The processing performed by each of the elements shown in the figures herein may be performed by a general purpose computer, and/or by a specialized processing computer. Such processing may be performed by a single platform, by a distributed processing platform, or by separate platforms. In addition, such processing can be implemented in the form of special purpose hardware, or in the form of software being run by a general purpose computer. Any data handled in such processing or created as a result of such processing can be stored in any type of memory. By way of example, such data may be stored in a temporary memory, such as in the RAM of a given computer system or subsystems. In addition, or in the alternative, such data may be stored in longer-term storage devices, for example, magnetic discs, rewritable optical discs, and so on. For purposes of the disclosure herein, machine-readable media may comprise any form of data storage mechanism, including such memory technologies as well as hardware or circuit representations of such structures and of such data. The processes may be implemented in any machine-readable media and/or in an integrated circuit.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus comprising:
at least one computer interface displaying a user interface configured to receive data supplied by at least one user;
a personalized marketing campaign knowledge database containing data encoding concepts extracted from complete personalized marketing campaigns and semantic definitions of those concepts;
and
a semantic inference engine to draw inferences based on a comparison of the semantics of the data entered by the at least one user and the semantic definitions of the concepts of personalized marketing campaigns encoded in the knowledge database, and to communicate those inferences via the user interface to the at least one user to assist the user in construction of the marketing campaign.

2. The apparatus according to claim 1 wherein the semantic definitions of campaign concepts are created using knowledge engineering of the real-world personalized marketing campaigns.

3. The apparatus according to claim 1 wherein the inference engine uses an automated reasoning system.

4. The apparatus according to claim 3 wherein the automatic reasoning system is an open world reasoner.

5. The apparatus according to claim 3 wherein the automatic reasoning system is rule based.

6. The apparatus according to claim 1 wherein the knowledge database contains semantic definitions of encoded concepts extracted from complete personalized marketing campaigns which have been knowledge engineered from complete personalized marketing campaigns.

7. The Apparatus according to claim 1 comprising plural computer interfaces, each displaying a user interface configured to receive data from plural users for the collaborative creation of a marketing campaign.

8. The apparatus according to claim 7 wherein the plural computer interfaces are connected via a network.

9. The apparatus according to claim 1 wherein the data supplied by the at least one user includes personalized information to be sent to at least one recipient.

10. The Apparatus according to claim 1 wherein the user interface includes a free-form field to receive free-form data from the at least one user.

11. The apparatus according to claim 1 wherein changes based upon the inferences are automatically incorporated into the marketing campaign.

12. The apparatus according to claim 1 wherein the inferences include suggestions for additional marketing campaign components.

13. The apparatus according to claim 1 wherein the inferences communicated to the user include identification of errors.

14. The apparatus according to claim 13 wherein the errors identified include the omission of necessary information.

15. The apparatus according to claim 14 wherein the omitted information includes recipient address information.

16. The apparatus according to claim 1 wherein the inferences communicated to the user include identification of inconsistencies.

17. The apparatus according to claim 16 wherein the inconsistencies include temporal inconsistencies.

18. The apparatus according to claim 1 wherein the content of information entered by the at least one user is automatically synchronized for new touchpoints.

19. A method comprising:
receiving personalized marketing campaign data from at least one user via at least one user interface;
drawing inferences from a comparison of the semantics of the data entered by the at least one user and the semantic definitions of concepts of personalized marketing campaigns stored in a knowledge database,
and
communicating the inferences to the at least one user to assist the user in construction of the marketing campaign.

20. Machine-readable media encoded with data, the data being interoperable with machine hardware to cause:
receiving personalized marketing campaign data from at least one user via at least one user interface;
drawing inferences from a comparison of the semantics of the data entered by the at least one user and the semantic definitions of concepts of personalized marketing campaigns stored in a knowledge database,
and
communicating the inferences to the at least one user to assist the user in construction of the marketing campaign.
